(19) United States
(12) Patent Application Publication
(10) Pub. No.: US 2009/0240581 A1
(43) Pub. Date: Sep. 24, 2009

(54) Web-based management system for print and copy services with advertisements

(75) Inventors: Brian J. Gallo, Fresno, CA (US); Brian Gagnon, Fresno, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: CopiFree, LLC

(21) Appl. No.: 12/077,843

(22) Filed: Mar. 21, 2008

(51) Int. Cl. G06Q 30/00

(52) U.S. Cl. 705/14

(57) ABSTRACT

An apparatus and method for a web-based management system for print and copy services with advertisements are presented. In one embodiment, the method includes receiving a document from a user of a web-based print and copy service to store at a main server of the web-based print and copy service, associating the document with an account of the user, the account to enable access privileges to the web-based print and copy service, determining one or more advertisements to target at the user based on an advertising profile associated with the user, merging the one or more advertisements with the document into a final document, presenting an access link for the final document to the user when the user accesses the account of the user, and providing the final document to the user when the user selects the access link associated with the document.

### FIELD OF THE INVENTION

The embodiments of the invention relate generally to print and copy services and, more specifically, relate to a web-based management system for print and copy services with advertisements.

### BACKGROUND

Frequently, large organizations, such as universities for example, have difficulty meeting demands for additional print resources. Convenience copiers are often provided to allow members of the organization to copy and print their documents for a small fee. However, these convenience copiers typically cost more than they produce.

One approach to address the increasing demands for additional print resources without overburdening the organization is to provide free printing and copying while utilizing the revenue from advertisements associated with the free prints and copies. Historically, this has been accomplished by placing pre-printed advertisements on the paper used in the machines for the free printing and copying. Any users of these machines can print or copy their documents, but will receive the printed or copied document with the pre-printed advertisement on back of the document, for example.

However, this manual advertisement system suffers from an inability to dynamically adjust to changing consumer desires and also is not adaptable to the particular user of the free copy and print services. Typically, the pre-printed paper is sold in large increments and with limited targeting capability. In addition, there is no feedback to advertisers of the end-users that receive their advertisements.

New media habits are changing the marketing landscape. Pop-up ads and banners are losing effectiveness. In addition, consumers, such as students at universities, can be difficult to reach with traditional media. As such, a way to dynamically provide advertisements to fund free copy and print services would be beneficial. A system that could target advertisements to individual users based on a profile including interests, age, gender, and so on, while also depending on their location would bring additional value to the organizations implementing such a system, as well as continuing to provide a valuable and convenient service to the end-user.

### BRIEF DESCRIPTION OF THE DRAWINGS

The invention will be understood more fully from the detailed description given below and from the accompanying drawings of various embodiments of the invention. The drawings, however, should not be taken to limit the invention to the specific embodiments, but are for explanation and understanding only.

FIG. 1 illustrates a block diagram of one embodiment of a system architecture for web-based management of print and copy services with advertisements;

FIG. 2 is a diagram depicting an exemplary utilization of a web-based management system for print and copy services with advertisements according to one embodiment of the invention;

FIG. 3 is a diagram depicting fundamentals of an advertising profile for an end-user of a web-based management system for print and copy services with advertisements according to one embodiment of the invention;

FIG. 4 depicts a screenshot of an installed virtual printer at a computing station of an end-user of a web-based management system for print and copy services with advertisements according to one embodiment of the invention;

FIG. 5 depicts a screenshot of a print queue displayed to an end-user at a print station of a web-based management system for print and copy services with advertisements according to one embodiment of the invention;

FIG. 6 depicts a screenshot of a customizable advertisement selection option presented to a user at a computing station of a web-based management system for print and copy services with advertisements according to one embodiment of the invention; and

FIG. 7 illustrates a block diagram of an exemplary computer system used in implementing one or more embodiments of the invention.

### DETAILED DESCRIPTION

A method and apparatus for a web-based management system for print and copy services with advertisements are described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the invention.

Embodiments of the invention introduce systems and methods for web-based management of print and copy services with advertisements. Throughout the following description, the web-based management of print and copy services with advertisements may be described with reference to a university setting with students as the end-users for exemplary purposes. One skilled in the art will appreciate that this is just one possible implementation for print and copy services, and embodiments of the invention are not limited to this implementation. Other implementations outside of the university setting are possible and furthermore envisioned for embodiments of the invention.

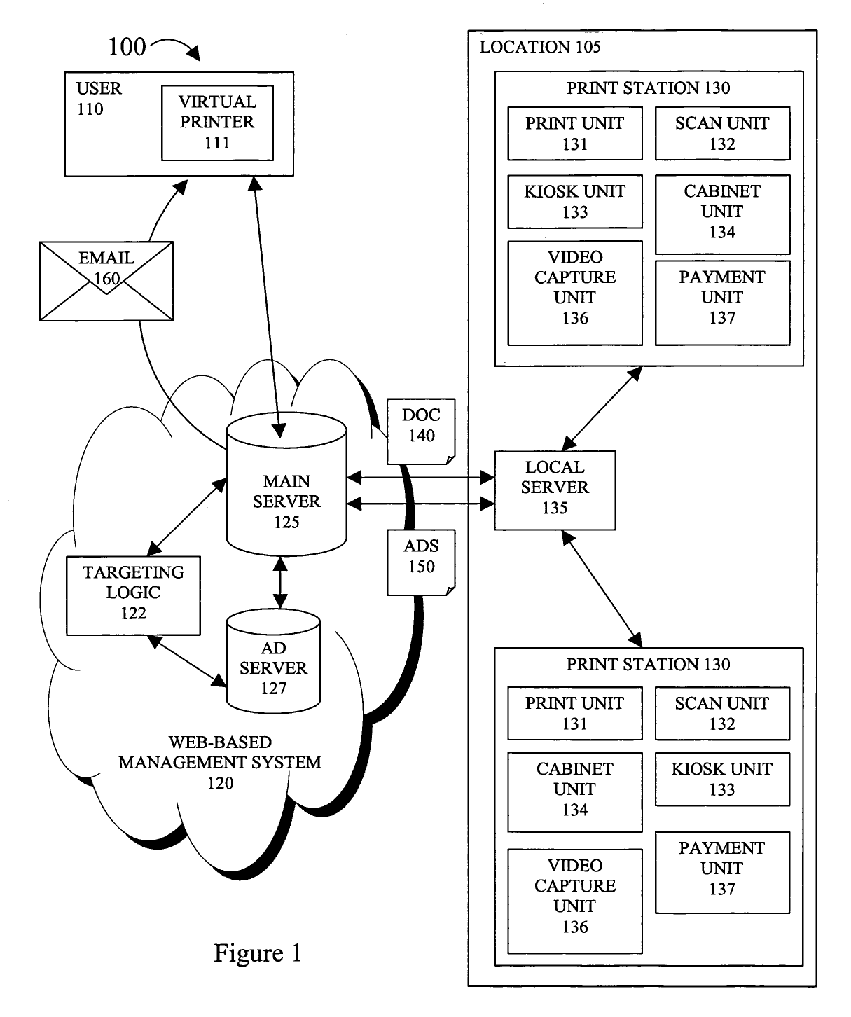

FIG. 1 is a block diagram depicting one embodiment of a system architecture for web-based management of print and copy services with advertisements. System 100 includes a user 110, a web-based management system 120, and one or more print stations 130 associated with the web-based management system 120. In some embodiments, the print stations may be located remotely from the web-based management system 120. User 110 may be a student at a university that utilizes the web-based management system 120 and print stations 130. In one embodiment, web-based management system 120 provides free print and copy services with advertisements to one or more user, such as user 110. User 110 utilizes the web-based management system 120 to print documents 140 provided by the user 110. In one embodiment, these provided documents are saved to the main server 125 of the web-based management system 120.

Then, the provided documents 140 may be retrieved at any of the print stations 130 by user 110. In one embodiment, user 110 may print the retrieved documents at the print station 130. In embodiments of the invention, these provided documents include advertisements 150 targeted to user 110. In other embodiments, user 110 may copy or scan documents at print station 130 and send these documents as a link in an email 160 to an email account of user 110 for later retrieval.

In some embodiments, in order for user 110 to utilize the free print and copy services of web-based management system 120, user 110 should establish a user account with web-based management system 120. This user account enables user 110 to download and install a virtual printer 111 at any machine the user 110 utilizes in order to provide documents to the web-based management system 120. In addition, a user account enables user 110 to access any documents previously provided by the user 110 to the web-based management system 120 and queued for printing at print stations 130 at one or more locations 105 remote to the user 110.

In some embodiments, the print station 130 of the web-based management system may contain a kiosk unit 133, which is the main controlling machine for all print and copy functions. It may also contain a print unit 131, which is the machine for printing all documents and a scan unit 132, which is the machine for scanning documents. In some embodiments, a single copy machine may incorporate both the scan unit and print unit. In addition, the print station may include a cabinet unit 134, which may include a space for paper storage with a table top providing accessories such as staplers and a hole punch, for example. In some embodiments, the kiosk unit 133 may be attached to an existing print unit 131, scan unit 132, and/or cabinet unit 134 already located at a place of installation of the kiosk unit 133.

Moreover, in some embodiments, the print station 130 may also include a video capture unit 136 (e.g., a video camera) and a payment unit 137 (e.g., a credit card purchasing machine) to allow users to buy prints and copies without advertising. In one embodiment, the video capture unit 136 may be utilized by the web-based management system for security purposes and to check for long lines at particular print station. One skilled in the art will appreciate that the contents of the print station may vary depending on the location and usage purposes of the print station.

In some embodiments, a local server 135 may be utilized to store various information associated with the user, documents and advertisements accessed at the print station 130. This local server may serve multiple print stations in a particular geographic region of the web-based management system. For example, a local server 135 may be utilized by all of the print stations located at a single university location.

In one embodiment, the advertisements 150 may be stored in a database at a separate advertisement server 127 located at the web-based management system 120. This advertisement server 127 may be accessed by advertising customers/subscribers to the web-based management system 120 in order to manage and update the specific advertisements of the advertising customer/subscriber located at the server 127. In other embodiments, the advertisement server 127 and the main server 125 may be a single server located at web-based management system 120.

In addition, targeting logic 122 located at web-based management system 120 may be utilized to target one or more of the advertisements stored at advertisement server 127 to one or more end-users, such as user 110, of the web-based management system 120. The processes taking place between user 110, web-based management system 120, and print stations 130 to enable print and copy services with advertisements are described in further detail below.

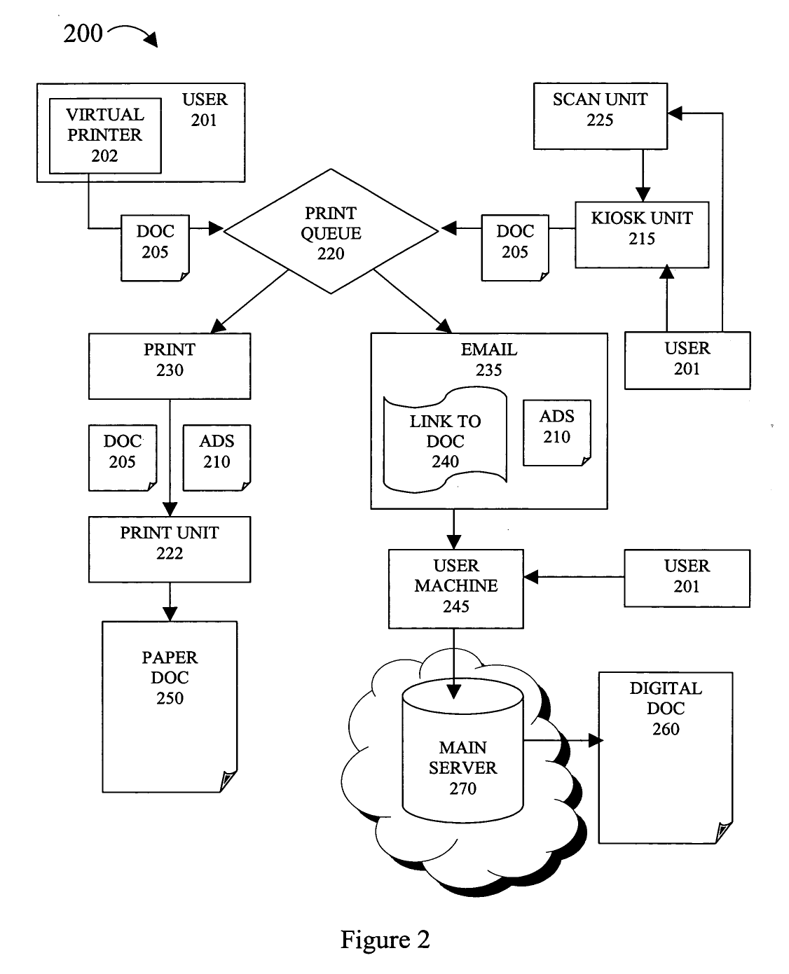

FIG. 2 is a diagram depicting an exemplary utilization 200 of a web-based management system for print and copy services with advertisements according to one embodiment of the invention. In embodiments of the invention, the utilization 200 of the web-based management system may take place in a system architecture such as system 100 described with respect to FIG. 1. In one embodiment, a user 201 logs into or creates an account with a web-based management system for print and copy services with advertisements.

In some embodiments, the user account enables the user 201 to download and install a virtual printer 202 to the machine that the user 201 is utilizing. The virtual printer 202 creates a virtual printer option on the machine enabling the user 201 to send one or more documents to the web-based management system for print and copy services. The virtual printer 202 is an installed program that converts a document to a standard file type and sends it to the web-based management system.

The user 201 may then select the virtual printer 202 from the list of installed printers on the user machine. The document 205 is then sent via the virtual printer to the web-based management system and made available in the user account's print queue 220. Subsequently, the user 201 may log into their account, or in other embodiments create an account, at a kiosk unit 215 of a print station or user machine 245 to access their print queue 220.

Subsequently, the user 201 is displayed or may access the print queue 220 associated with the user's account at the kiosk unit 215. This print queue 220 contains a list of all of the documents the user has sent via the virtual printer 202 to print. As such, the print queue 220 contains the document 205 sent via the virtual printer 202 as discussed above. In one embodiment, the user may then select this document to print 230 at a print unit 222 located at the print station.

In one embodiment, when the document is sent to the print unit 222, the web-based management system dynamically merges one or more advertisements 210 with the document 205. In some embodiments, these advertisements 210 may be printed on the back of the printed document 250 as a double-sided document. In another embodiment, the advertisements 210 may be printed as a header/footer and/or a frame on the front and/or the back sides of the document 250. Other printing layout options are also envisioned, such as watermarking and utilizing extra print out sheets included with the document. One skilled in the art will appreciate that the above examples are not inclusive of possible advertisement template styles. In some embodiments, the user may have the option to select the desired print layout for the advertisements on the printed document 250.

In some embodiments, the web-based management system includes targeting logic, such as targeting logic 122 described with respect to FIG. 1, to dynamically select the one or more advertisements 210 to be merged with the document 205 based on an advertising profile of the user. In some embodiments, the advertising profile of the user may be established based on information obtained from the user when the user created their account with the web-based management system. For instance, based on login information of the user, the web-based management system can access an account of the user and know where the user is printing, whether the user is male or female, the age of the user (based on the birthday of the user), who the user is and which ads have been previously printed to that user, and the number of pages in the pending document.

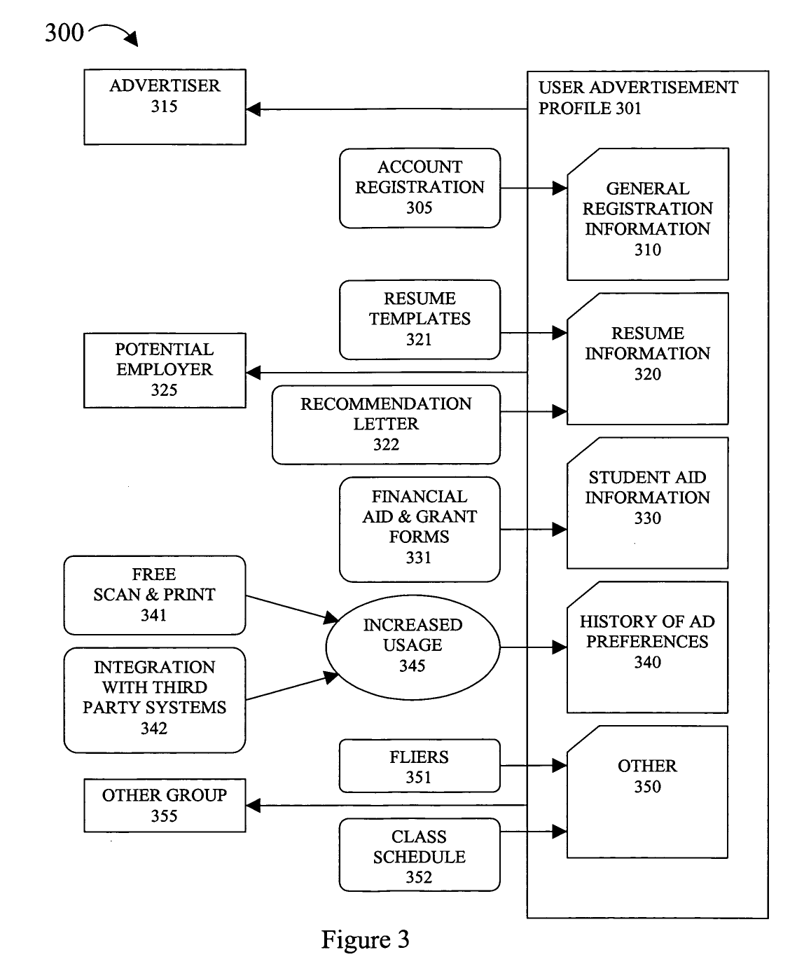

In addition, the user 201 may be prompted at the kiosk unit 215, or at another machine of the user, to select advertisers or specific advertisements they would prefer to be merged with the printed document 250. This information may be stored in the profile of the user for later reference by the web-based management system. These are just a few example possibilities for targeting advertisements to a user. FIG. 3 below depicts the various possibilities that may be used to establish an advertising profile of a user according to embodiments of the invention.

In another embodiment, the user 201 may utilize the print station of the web-based management system to copy or scan a document 205 that the user physically brings to the scan unit 225 of the print station. If the user wishes to copy the document, the user may select a “copy” option provided to the user at the kiosk unit 215, which will prompt the user to place the document on the scan unit 225 and select a “Start Copy” option when ready. Then, a copy is made that merges the one or more advertisements 210 targeted to the user on the back of the double-sided printed document 250 or as a frame on both sides, for example.

In yet another embodiment, the user 201 may scan the document 205 at the scan unit 225 and either print it immediately at the print unit 222 or save the document for retrieval at a later time. If the user wishes to access a scanned copy of the document at a later time, the kiosk unit 215 provides the user the option to send the document 205 as a link 240 in an email 235. This email 235 may be sent to an email associated with the user's account at the web-based management system, or may be an email provided by the user at the kiosk unit 215.

In one embodiment, when the link for the document 240 is created, it is stored at a main server 270 of the web-based management system along with one or more advertisements 210 targeted to the user 201 per the above discussion. When the user accesses the email 235, they may follow the link 240 to the document 260 with its merged one or more advertisements 210 that are stored at the main server 270 of the web-based management system. The user may then download the document 260, with its associated advertisements 210, to the machine 245 where the user 201 has accessed the link 240 in the email 235.

In some embodiments, advertisers may be customers of the web-based management system and provide the advertisements that are targeted to the end-users of the free print and copy services of the web-based management system In embodiments of the invention, web-based management system provides the unique ability to target advertisements to the end user of the web-based management system based on various information the web-based management system gathers related to the individual end-users of the system, as well as based on locations of the print stations utilized by the end-users.

FIG. 3 is a diagram depicting the architecture 300 of an advertising profile 301 for an end-user of a web-based management system for print and copy services with advertisements according to one embodiment of the invention. In one embodiment, FIG. 3 is depicted in the context of a student as the end-user of the web-based management system, where the free print and copy services are provided at various locations throughout a university that the student attends.

Once the student creates an account with the web-based management system for print and copy services with advertisements, an advertisement profile 301 is created for the student. Inputs into this advertisement profile 301 include the general registration information 310 provided by the student when they created the account 305. This general registration information may include a gender of the student, a birthday of the student (to determine age), a location of the student, an email of the student, any advertising preferences of the student, and so on.

In addition, the student may be offered the capability to design, submit and print resumes, job applications, and financial aid applications for free without advertisements on the documents 321, 331. In such a situation, the student may utilize templates provided by the web-based management system and enter in the specific information 320, 330 for these documents 321, 331. Recommendation letters 322 may also be scanned and stored with resume information 320 and student aid information 330 in the advertisement profile 301.

The web-based management system may then utilize the resume information 320 and student aid information 330 as part of the advertisement profile 301 of the student. It is envisioned that other documents may be offered for free printing without advertisements based on the value of the information within the document, and that the types of documents subject to the free printing without advertisements are not limited to solely those documents discussed above.

In one embodiment, advertising customers of the web-based management system may utilize the advertisement profile 301 of the student to discover potential candidates for open positions of the advertising customer 325. In addition, the advertising customer may utilize this information to market their open positions to the potential candidates.

In some embodiments, the student may specify advertisers and particular advertisements they would prefer to print with documents at the print station of the web-based management system or to include with copied or scanned documents. This information is kept as a history of advertisement preferences 340 associated with the student, and as such is an input into the user advertisement profile 301 of the student.

In some embodiments, the web-based management system may be utilized to print directly from any third party systems, such as online social networking application, photo sharing websites, other sources of web content, and any type of computing device (e.g., MySpace, Facebook, Flickr, Virb, Photobucket, Picasa, Gmail, PDA, Blackboard, etc.) 342. Such a capability increases traffic 345 to the web-based management system, and thereby the advertisement opportunities for customers of the web-based management system.

In some embodiments, the web-based management system may be utilized to print fliers and distribute digital fliers 351 from university groups 355 approved by the user, for example. These fliers 351 can be added to the user print queue for the user to choose to print the flier or view and delete. Users choose to continue to allow future fliers from the group or block that group. This information is kept as a history of interests 350 associated with the student, and as such is an input into the user advertisement profile 301 of the student.

In some embodiments, users of the web-based management system, for example professors of a university, may provide course material to be made available for student access. Student users may add their current class schedule 352 to their user profile 301 and search for available course material that pertains to their needs. These course materials may be printed at any print station.

The above discussion and illustration in FIG. 3 of a user advertisement profile 301 is provided for exemplary purposes. One skilled in the art will appreciate that the user advertisement profile 301 may include other inputs than those discussed here and depicted in FIG. 3. The above discussion and illustration are not meant to be limiting to the possible inputs affecting a user advertisement profile, and various other inputs are envisioned and expected.

In some embodiments, when a document is merged with one or more advertisements, various levels of filtering may take place to target the particular advertisements to the end-user. In one embodiment, a first level of filtering may include filtering advertisements based on a location of the user. For instance, some locations may not allow certain types of advertisements, such as those related to alcohol. As a result, the first level of filtering will remove any alcohol advertisements from targeting considered towards the end-user. Then, a second level of filtering may take place based on the advertisement profile 310 of the user.

In some embodiments, instead of (or in addition to) a printed advertisement being sent to the user, a video advertisement may be presented to the user at a screen of a kiosk unit of a print station of the web-based management system based on the various dynamic filtering that has taken place (e.g., based at least in part on the location and advertisement profile of the user). In some embodiments, advertising customers of the web-based management system may be able to customize their level of filtering and targeting based on a particular subscription to the web-based management system they may hold.

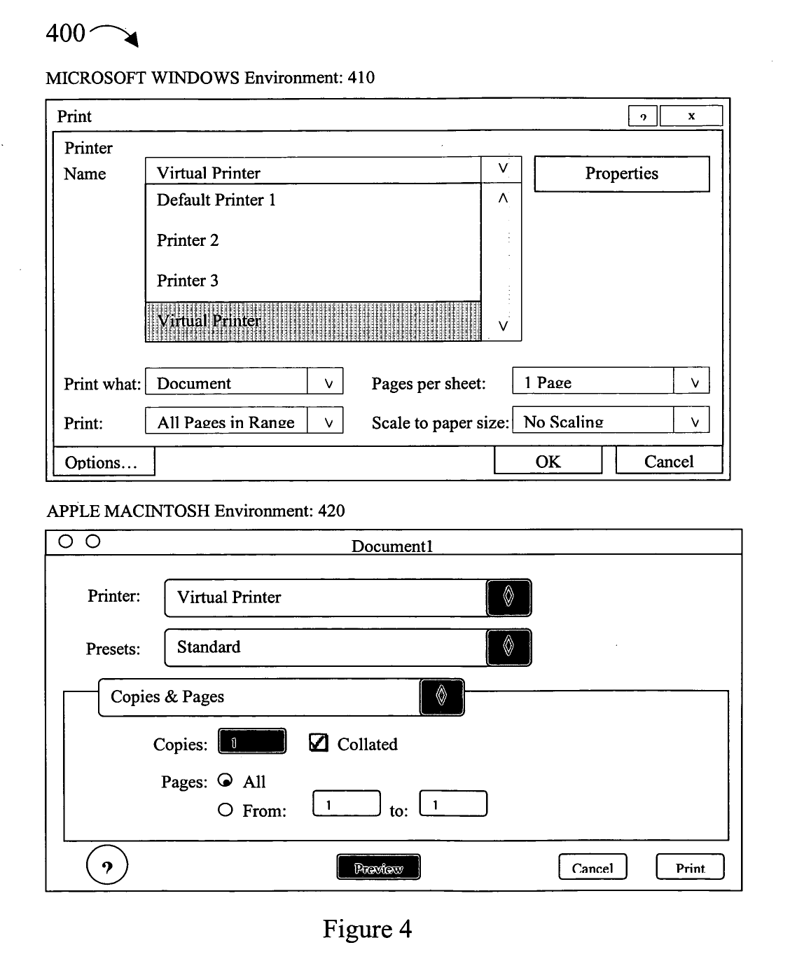

FIGS. 4 through 6 depict various exemplary screenshots of functionalities and offerings related to the web-based management system for print and copy services with advertisements according to embodiments of the invention.

FIG. 4 depicts a screenshot of an installed virtual printer at computing station of an end-user according to one embodiment of the invention. The virtual printer may be downloaded and installed at the computing station of the end-user. The virtual printer is provided by the web-based management system for print and copy services. The end-user may then select this installed virtual printer to send documents to the web-based management system to print at a print station of the web-based management system.

Specifically, FIG. 4 depicts a screenshot of the installed virtual printer in a MICROSOFT WINDOWS environment 410, and also in an APPLE MACINTOSH environment 420. One skilled in the art will appreciate that these are exemplary environments and other computing environments may also be utilized.

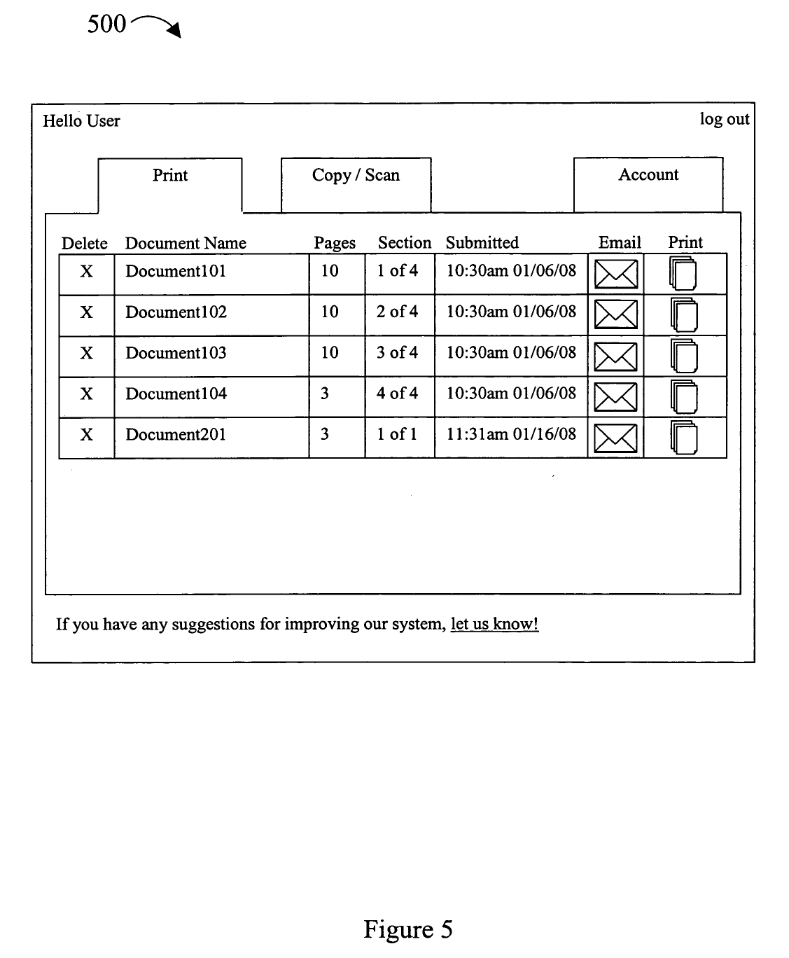

FIG. 5 depicts a screenshot of a print queue shown to an end-user at a kiosk unit of a print station of the web-based management system for print and copy services with advertisements according to one embodiment of the invention. The print queue is shown at the kiosk unit when an end-user accesses their user account at the print station. The print queue shows all documents sent via the virtual printer by the end-user and waiting for print. In addition, the end-user may be able to delete unwanted print jobs from the print queue.

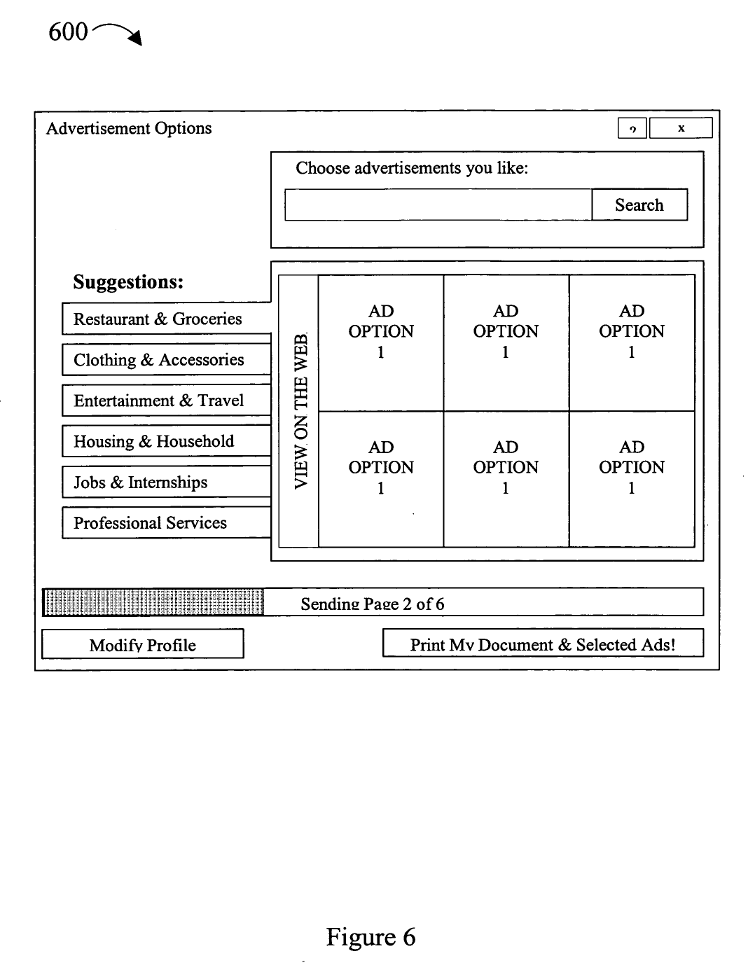

FIG. 6 depicts a screenshot of a customizable advertisement selection option presented to an end-user of the web-based management system at any machine utilized by the end-user when trying to print, scan, or copy a document according to embodiments of the invention. This screen allows an end-user to select preferred advertisers or advertisements, as well as search advertisers or advertisements, to be merged with the document that the end-user is trying to print, copy, or scan.

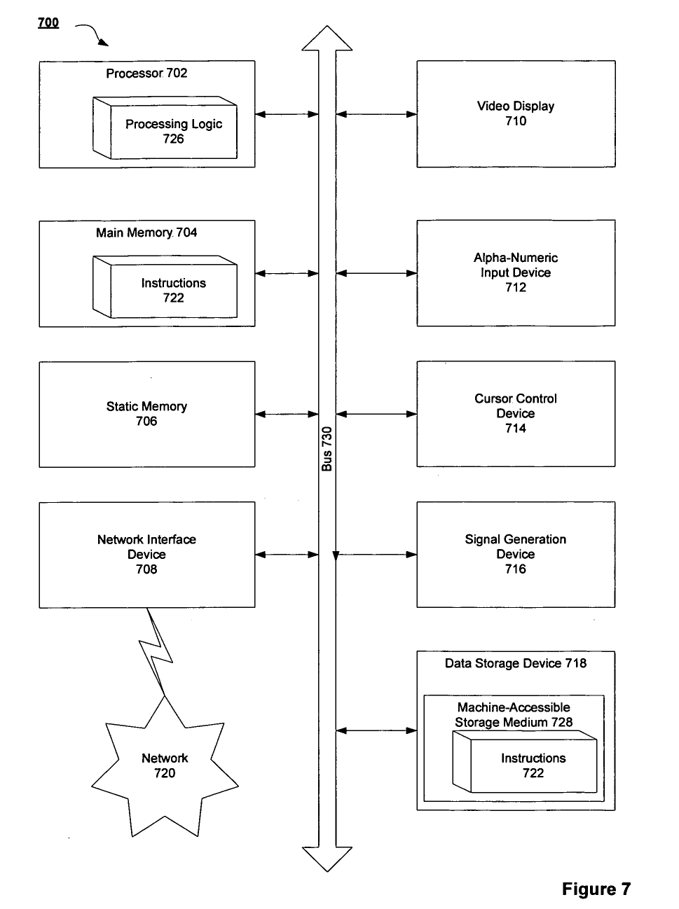

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a LAN, an internet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium 728 on which is stored one or more set of instructions (e.g., software 722) embodying any one or more of the methodologies of functions described herein. The software 722 may also reside, completely or at least partially, within the main memory 704 and/or within the processing device 702 during execution thereof by the computer system 700; the main memory 704 and the processing device 702 also constituting machine-accessible storage media. The software 722 may further be transmitted or received over a network 720 via the network interface device 708. In one embodiment, the network interface device 708 may be operable to receive messages from the broadcaster or the recipient as described above in various embodiments of the invention.

The machine-readable storage medium 728 may be used to store logic (such as targeting logic 122 described with respect to FIG. 1) of the web-based management system for print and copy services with advertisements that operate to dynamically target and filter advertisements to end-users of the system, and/or a software library containing methods that call the above applications of embodiments of the invention. While the machine-accessible storage medium 728 is shown in an exemplary embodiment to be a single medium, the term “machine-accessible storage medium” should be taken to include a single medium or multiple media (e.g., a centralized or distributed database, and/or associated caches and servers) that store the one or more sets of instructions. The term “machine-accessible storage medium” shall also be taken to include any medium that is capable of storing, encoding or carrying a set of instruction for execution by the machine and that cause the machine to perform any one or more of the methodologies of the present invention. The term “machine-accessible storage medium” shall accordingly be taken to include, but not be limited to, solid-state memories, and optical and magnetic media.

In the above description, numerous specific details such as logic implementations, opcodes, resource partitioning, resource sharing, and resource duplication implementations, types and interrelationships of system components, and logic partitioning/integration choices may be set forth in order to provide a more thorough understanding of various embodiments of the invention. It will be appreciated, however, to one skilled in the art that the embodiments of the invention may be practiced without such specific details, based on the disclosure provided. In other instances, control structures, gate level circuits and full software instruction sequences have not been shown in detail in order not to obscure the invention. Those of ordinary skill in the art, with the included descriptions, will be able to implement appropriate functionality without undue experimentation.

The various embodiments of the invention set forth above may be performed by hardware components or may be embodied in machine-executable instructions, which may be used to cause a general-purpose or special-purpose processor or a machine or logic circuits programmed with the instructions to perform the various embodiments. Alternatively, the various embodiments may be performed by a combination of hardware and software.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising:
receiving a document from a user of a web-based print and copy service to store at a main server of the web-based print and copy service;
associating the document with an account of the user, the account to enable access privileges to the web-based print and copy service;
determining one or more advertisements to target at the user based on an advertising profile associated with the user;
merging the one or more advertisements with the document into a final document;
presenting an access link for the final document to the user when the user accesses the account of the user; and
providing the final document to the user when the user selects the access link associated with the document.

2. The method of claim 1, wherein providing the final document to the user includes printing the final document at a print station of the web-based print and copy service, and the access link for the final document is a link in a print queue displayed to the user at the print station.

3. The method of claim 1, wherein receiving the document includes the user copying the document at a print station of the web-based print and copy service, wherein presenting the access link includes sending the access link in an email to an email account of the user, and wherein providing the final document includes the user selecting the access link to access the final document.

4. The method of claim 1, wherein merging the document with the one or more advertisements includes locating the one or more advertisements on at least one of an opposing page side of the document, a frame on both sides of the document, a header on both sides of the document, and a footer on both sides of the document to enable double-sided printing for the user.

5. The method of claim 1, wherein the advertising profile associated with the user includes information provided by the user when the user created the account for the web-based print and copy service.

6. The method of claim 1, wherein the advertising profile associated with the user includes information obtained from at least one of a resume of the user, a financial aid application of the user, a recommendation letter for the user, and a history of advertisement preferences selected by the user.

7. The method of claim 1, wherein the one or more targeted advertisements are selected by the user when the user provides the document to the web-based print and copy service.

8. The method of claim 1, further comprising providing a virtual printer program to the user, via download from the web-based print and copy service, in order to install a virtual printer on a machine of the user, the virtual printer to enable the user to provide the document to the web-based print and copy service.

9. The method of claim 1, further comprising targeting the one or more advertisements to the user by filtering advertisements based on a location of the user.

10. The method of claim 1, wherein the user provides one or more other documents to the web-based print and copy service and accesses the one or more other documents via one or more access links when the user accesses the account.

11. A system to provide management of web-based print and copy services, the system comprising:
a server to store:
one or more documents provided to the server by a user of the web-based print and copy service, the one or more documents associated with an account of the user that enables access privileges to the web-based print and copy service;
a database of advertisements provided to the server by advertising subscribers of the web-based print and copy service; and
an advertising profile associated with the user;
targeting logic communicably coupled to the server, the targeting logic to:
determine one or more advertisements from the database of advertisements to target at the user based on the advertising profile of the user;
merge the determined one or more advertisements with one of the one or more documents into a final document; and
present an access link for the final document to the user when the user accesses the account of the user; and
a print station communicably coupled to the server and the targeting logic, the print station to provide the final document to the user when the user accesses the access link at the print station.

12. The system of claim 11, wherein the print station to provide the one or more final documents to the user by printing the one or more final documents at a print unit located at the print station.

13. The system of claim 11, wherein the user provides the one or more documents to the server by scanning the one or more documents at the print station, and wherein the targeting logic presents the access link by sending the access link in an email to an email account of the user.

14. The system of claim 11, wherein the targeting logic merges the one or more advertisements with the one document by locating the one or more advertisements on at least one of an opposing page side of the document, a frame on both sides of the document, a header on both sides of the document, and a footer on both sides of the document to enable double-sided printing for the user.

15. The system of claim 11, wherein the advertising profile associated with the user includes information provided by the user when the user created the account at the web-based print and copy service.

16. The system of claim 11, wherein the advertising profile associated with the user includes information obtained from at least one of a resume of the user, a financial aid application of the user, a recommendation letter for the user, and a history of advertisement preferences selected by the user.

17. The system of claim 11, wherein the one or more targeted advertisements are selected by the user when the user provides the one or more documents to the server.

18. A machine-accessible medium having stored thereon data representing sets of instructions that, when executed by a machine, cause the machine to perform operations comprising:
receiving a document from a user of a web-based print and copy service to store at a main server of the web-based print and copy service;
associating the document with an account of the user, the account to enable access privileges to the web-based print and copy service;
determining one or more advertisements to target at the user based on an advertising profile associated with the user;
merging the one or more advertisements with the document into a final document; and
providing the final document to the user at a print station of the web-based print and copy service when the user accesses the account at the print station and selects the final document to print at the print station.

19. The machine-accessible medium of claim 18, wherein merging the document with the one or more advertisement includes locating the one or more advertisements on at least one of an opposing page side of the document, a frame on both sides of the document, a header on both sides of the document, and a footer on both sides of the document to enable double-sided printing for the user.

20. The machine-accessible medium of claim 18, wherein the advertising profile associated with the user includes information provided by the user when the user created the account for the web-based print and copy service.

21. The machine-accessible medium of claim 18, wherein the advertising profile associated with the user includes information obtained from at least one of a resume of the user, a financial aid application of the user, a recommendation letter for the user, and a history of advertisement preferences selected by the user.

22. The machine-accessible medium of claim 18, wherein the one or more targeted advertisements are selected by the user when the user provides the document to the web-based print and copy service.

23. The machine-accessible medium of claim 18, wherein the data representing sets of instructions, when executed by the machine, cause the machine to perform further operations comprising providing a virtual printer program to the user, via download from the web-based print and copy service, in order to install a virtual printer on a machine of the user, the virtual printer to enable the user to provide the document to the web-based print and copy service.
